(19) United States
(12) Patent Application Publication
(10) Pub. No.: US 2025/0193861 A1
(43) Pub. Date: Jun. 12, 2025

(54) NOISE POWER AND SIGNAL-TO-NOISE RATIO ESTIMATION METHOD AND DEVICE IN WIRELESS COMMUNICATION SYSTEM

(71) Applicant: SAMSUNG ELECTRONICS CO., LTD., Suwon-si (KR)

(72) Inventors: Youngwook SON, Suwon-si (KR); Hyunbae JEON, Suwon-si (KR); Jung Woon LEE, Suwon-si (KR)

(73) Assignee: SAMSUNG ELECTRONICS CO., LTD., Suwon-si (KR)

(21) Appl. No.: 18/940,242

(22) Filed: Nov. 7, 2024

(30) Foreign Application Priority Data
Dec. 6, 2023 (KR) 10-2023-0175445

(51) Int. Cl. H04W 72/0453; H04W 72/541

(52) U.S. Cl. CPC H04W 72/0453; H04W 72/541

(57) ABSTRACT

A method of a wireless communication device, includes compensating for a first phase of a first training symbol and a second phase of a second training symbol following the first training symbol, based on a reference carrier frequency offset (CFO) corresponding to one of a plurality of subcarriers of a received frame in a time domain; calculating residual CFOs respectively for the plurality of subcarriers of the received frame, based on the reference CFO; compensating for phase differences between the first training symbol and the second training symbol for each of the plurality of subcarriers, based on the residual CFOs in a frequency domain; and estimating at least one of noise power and signal-to-noise ratio (SNR) of the received frame, based on the first training symbol and the second training symbol after compensating for the phase differences between the first training symbol and the second training symbol.

### CROSS-REFERENCE TO RELATED APPLICATION

This application is based on and claims priority under 35 USC § 119 to Korean Patent Application No. 10-2023-0175445, filed on Dec. 6, 2023, in the Korean Intellectual Property Office, the disclosure of which is incorporated by reference herein in its entirety.

### BACKGROUND

### 1. Field

The disclosure relates to a noise power and signal-to-ratio noise (SNR) estimation method and device for improving communication performance.

### 2. Description of Related Art

Wireless local area network (WLAN), as an example of wireless communication, is a technology that connects two or more devices using a wireless signal transmission method. The WLAN technology may be based on the IEEE (institute of electrical and electronics engineers) 802.11 standard. The 802.11 standard has evolved into 802.11b, 802.11a, 802.11g, 802.11n, 802.11ac, and 802.11ax and may support a transfer rate up to 1 Gbyte/s based on orthogonal frequency-division multiplexing (OFDM) technology.

In 802.11ac, data may be transmitted simultaneously to multiple users through a multi-user multi-input multi-output (MU-MIMO) technique. In 802.11ax, referred to as high efficiency (HE), available subcarriers are divided to be provided to users by using MU-MIMO and orthogonal frequency-division multiple access (OFDMA) technology, so that multi-access is implemented. Through the multi-access, a WLAN system using 802.11ax may effectively support communication in dense regions and outside regions.

802.11be, referred to as extremely high throughput (EHT), seeks to implement support of a 6 GHz unlicensed frequency band, support of various bandwidths per channel, introduction of hybrid automatic repeat and request (HARQ), and support of up to 16′16 MIMO. In 802.11be, the next-generation WLAN system is expected to effectively support low latency and high-speed transmission like new radio (NR), a 5G technology. Further, a new technology supporting a bandwidth of up to 640 MHz per channel in 802.11be has been recently proposed to increase spectral efficiency and transfer rate.

In a wideband wireless communication system, a carrier frequency of a signal transmitted by a transmitting device and a carrier frequency of a received signal recognized by a receiving device may differ due to one or more factors. Considering these factors, a method for estimating noise power and signal-to-noise ratio (SNR)) is required.

### SUMMARY

Provided are a method and a device for estimating noise power and signal-to-noise ratio (SNR) so as to improve communication performance.

According to an aspect of the disclosure, a method of a wireless communication device, includes: compensating for a first phase of a first training symbol and a second phase of a second training symbol following the first training symbol, based on a reference carrier frequency offset (CFO) corresponding to one of a plurality of subcarriers of a received frame in a time domain; calculating residual CFOs respectively for the plurality of subcarriers of the received frame, based on the reference CFO; compensating for phase differences between the first training symbol and the second training symbol for each of the plurality of subcarriers, based on the residual CFOs in a frequency domain; and estimating at least one of noise power and signal-to-noise ratio (SNR) of the received frame, based on the first training symbol and the second training symbol after compensating for the phase differences between the first training symbol and the second training symbol, based on the residual CFOs.

According to another aspect of the disclosure, a wireless communication device includes: a compensator configured to compensate for a first phase of a first training symbol and a second phase of a second training symbol following the first training symbol, based on a reference carrier frequency offset (CFO) corresponding to one of a plurality of subcarriers of a received frame in a time domain; a CFO calculator configured to determine the reference CFO and determine residual CFOs respectively for the plurality of subcarriers of the received frame, based on the reference CFO; and a signal-to-noise ratio (SNR) estimator configured to estimate at least one of noise power and an SNR of the received frame, based on the first training symbol and the second training symbol, wherein the compensator is further configured to compensate for phase differences between the first training symbol and the second training symbol for each of the plurality of subcarriers, based on the residual CFOs in a frequency domain, and wherein the SNR estimator is further configured to estimate at least one of the noise power and the SNR after the phase differences between the first training symbol and the second training symbol are compensated for by the compensator, based on the residual CFOs.

According to another aspect of the disclosure, a method of a wireless communication device, includes: estimating a frequency offset of a received frame; determining a reference carrier frequency offset (CFO) corresponding to one of a plurality of subcarriers of the received frame, based on the estimated frequency offset; compensating for a first phase of a first training symbol and a second phase of a second training symbol following the first training symbol, based on the reference CFO in a time domain; calculating residual CFOs respectively for the plurality of subcarriers of the received frame, based on the reference CFO; compensating for phase differences between the first training symbol and the second training symbol for each of the plurality of subcarriers, based on the residual CFOs; and estimating at least one of noise power and a signal-to-noise ratio (SNR) of the received frame, based on the first training symbol and the second training symbol, after the phase differences of the first training symbol and the second training symbol are compensated for based on the residual CFOs.

### BRIEF DESCRIPTION OF DRAWINGS

Embodiments will be more clearly understood from the following detailed description taken in conjunction with the accompanying drawings in which:

FIG. 1 is a diagram illustrating a wireless communication system according to an embodiment;

FIG. 2 is a block diagram of a wireless communication device according to an embodiment;

FIG. 3 is a block diagram of a wireless communication device according to an embodiment;

FIG. 4A is a flowchart illustrating an operation sequence of a wireless communication device according to an embodiment;

FIG. 4B is a diagram illustrating a sampling clock offset (SCO);

FIG. 4C illustrates a clock frequency offset (CFO) and a SCO in a frequency domain;

FIG. 5A is a flowchart illustrating an operation sequence of a wireless communication device according to an embodiment;

FIG. 5B is a graph illustrating a CFO, reference CFO, and residual CFO according to subcarrier index;

FIG. 5C illustrates an operation sequence for determining a reference CFO based on a bandwidth of a received frame;

FIGS. 5D and 5E illustrate graphs related to embodiments of determining a reference CFO based on a bandwidth of a received frame;

FIG. 6 is a flowchart illustrating an operation sequence of a wireless communication device according to an embodiment;

FIG. 7A is a flowchart illustrating an operation sequence of a wireless communication device according to an embodiment;

FIG. 7B illustrates an example of a preamble structure of a wireless local area network (WLAN) frame;

FIG. 7C is a flowchart illustrating an operation sequence of a wireless communication device according to an embodiment;

FIG. 7D is a block diagram of a wireless communication device according to an embodiment;

FIG. 8A illustrates a division of a channel of a received frame according to an embodiment;

FIGS. 8B and 8C illustrate signal-to-noise ratios (SNRs) estimated considering a sampling clock offset (SCO)-coupled effect in an additive white Gaussian noise (AWGN) channel according to an embodiment;

FIGS. 8D and 8E illustrate SNRs estimated considering an SCO-coupled effect in a fading channel according to an embodiment; and

FIG. 9 is a diagram illustrating examples of devices for wireless communication according to an embodiment.

### DETAILED DESCRIPTION

The terms as used in the disclosure are provided to merely describe specific embodiments, not intended to limit the scope of other embodiments. Singular forms include plural referents unless the context clearly dictates otherwise. The terms and words as used herein, including technical or scientific terms, may have the same meanings as generally understood by those skilled in the art. The terms as generally defined in dictionaries may be interpreted as having the same or similar meanings as or to contextual meanings of the relevant art. Unless otherwise defined, the terms should not be interpreted as ideally or excessively formal meanings. Even though a term is defined in the disclosure, the term should not be interpreted as excluding embodiments of the disclosure under circumstances.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

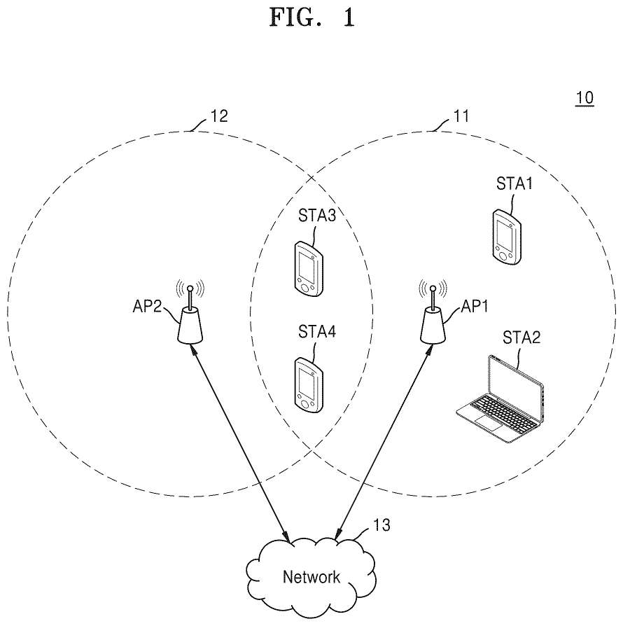

FIG. 1 is a diagram illustrating a wireless communication system 10 according to an embodiment.

In detail, FIG. 1 illustrates a wireless local area network (WLAN) system as an example of the wireless communication system 10. In describing embodiments in detail, although orthogonal frequency-division multiplexing (OFDM) or orthogonal frequency-division multiple access (OFDMA)-based wireless communication systems, especially, IEEE 802.11 standard will be the main subject, a main gist of the disclosure may be slightly modified to be also applied to other communication systems having similar technical background and channel types (e.g., long term evolution (LTE), LTE-advanced (LTE-A), new ratio (NR), wireless broadband (WiBro), and global system for mobile communication (GSM) or short-range communication systems, such as Bluetooth and near field communication (NFC) within the scope of the disclosure, which may be determined at the discretion of a person skilled in the art of the disclosure.

In addition, various functions described below may be implemented or supported by artificial intelligence (AI) technology or one or more computer programs, each of which includes computer-readable program code and is implemented on a computer-readable medium. The terms “application” and “program” refer to one or more computer programs, software components, sets of instructions, procedures, functions, objects, classes, instances, associated data, or portions thereof suitable for implementation of suitable computer-readable program code. The term “computer-readable program code” includes all types of computer code, including source code, object code, and executable code. The term “computer-readable medium” includes all types of mediums that may be accessed by computers, such as read only memory (ROM), random access memory (RAM), hard disk drive, compact disk (CD), digital video disk (DVD), or any other type of memory. “Non-transitory” computer-readable mediums exclude wired, wireless, optical, or other communication links that transmit transient electrical or other signals. Non-transitory computer-readable mediums include a medium on which data may be permanently stored and a medium on which data may be stored and later overwritten, such as rewritable optical disks or erasable memory devices.

In one or more embodiments described below, a hardware approach is described as an example. However, because one or more embodiments include technology using both hardware and software, one or more embodiments do not exclude software-based approaches.

In addition, terms referring to control information, terms referring to entries, terms referring to network entities, terms referring to messages, terms referring to device components, etc. used in the descriptions given below are examples. The disclosure is not limited to the terms described below, and other terms having equivalent technical meaning may be used.

Referring to FIG. 1, the wireless communication system 10 includes first and second access points AP1 and AP2, a first station STA1, a second station STA2, a third station STA3, and a fourth station STA4. The first and second access points AP1 and AP2 may be connected to a network 13 including the Internet, an Internet protocol (IP) network, or any other network. The first access point AP1 may provide the first station STA1, the second station STA2, the third station STA3, and the fourth station STA4 with access to the network 13 within a first coverage region 11, and the second access point AP2 may also provide the third station STA3 and the fourth station STA4 with access to the network 13 within a second coverage region 12. In some embodiments, the first and second access points AP1 and AP2 may communicate with at least one of the first station STA1, the second station STA2, the third station STA3, and the fourth station STA4, based on wireless fidelity (WiFi) or any other WLAN access technology.

An access point may be referred to as a router, a gateway, etc., and a station may be referred to as a mobile station, a subscriber station, a terminal, a mobile terminal, a wireless terminal, a user equipment, or a user. The station may be a mobile device, such as a mobile phone, laptop computer, wearable device, etc., or a stationary device, such as a desktop computer, smart TV, etc.

The access point may determine a channel bandwidth used to communicate with a station, as one of a plurality of channel bandwidths. In the disclosure, a channel bandwidth may also be referred to as a bandwidth. In an embodiment, the plurality of channel bandwidths may include 20 MHz, 40 MHz, 80 MHz, 160 MHz, 320 MHz, and 640 MHz.

An access point and a station according to an embodiment may estimate noise power and a signal-to-noise ratio (SNR) by considering even a difference between sampling clocks of an analog-to-digital converter (ADC) and a digital-to-analog converter (DAC), as well as a difference in local oscillator clock between an access point and a station.

The access point and station according to an embodiment may accurately estimate noise power and SNR using training symbols that maintain repeatability.

The access point and station according to an embodiment may minimize inter-carrier interference (ICI) in the process of estimating the noise power and the SNR.

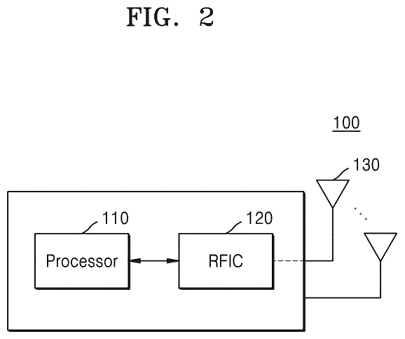

FIG. 2 is a block diagram of a wireless communication device 100 according to an embodiment.

In a wireless communication system, it may be difficult for the clock frequencies of local oscillators (LO) respectively driven by transmitting and receiving devices to exactly match each other. Thus, a carrier frequency of a signal transmitted by the transmitting device may be different from a carrier frequency of a received signal recognized by the receiving device. In the disclosure, a frequency offset that occurs for this reason is referred to as a ‘carrier frequency offset’ (CFO). When the CFO exists, the receiving device recognizes a subcarrier of a transmission signal as being shifted by a certain frequency gap.

A difference in sampling clock frequencies (frequencies of sampling clocks) applied to analog-to-digital signal conversion may cause a frequency offset. That is, the difference in the sampling clock frequencies between the transmitting device and the receiving device may cause a frequency offset. In detail, a difference between the frequency of the sampling clock of an analog-to-digital converter (ADC) and the frequency of the sampling clock of a digital-to-analog converter (DAC) may cause a frequency offset between the transmitting device and the receiving device. In the disclosure, such a frequency offset is referred to as a ‘sampling clock offset’ (SCO). The SCO may occur in conjunction with a CFO. For example, the SCO may affect the degree of CFO. In detail, the SCO may have different degrees of influence on the CFO depending on a frequency band of the frame. Accordingly, CFOs may have different deviations in subbands having different frequency positions. That is, subcarriers of the frame may be affected by the SCO to different degrees and may have different CFO deviations.

Referring to FIG. 2, the wireless communication device 100 includes a processor 110 (or at least one processor 110), a radio frequency integrated circuit (RFIC) 120, and antennas 130. The wireless communication device 100 may further include components for transmitting and receiving signals and data. For example, the wireless communication device 100 may further include a local oscillator.

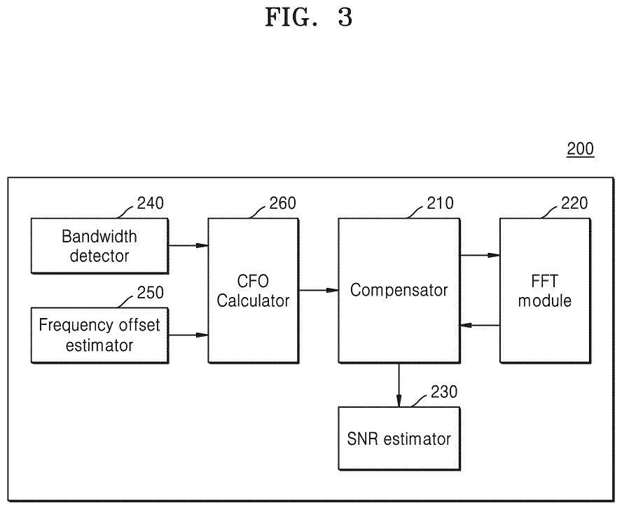

In this disclosure, the processor 110 (or the at least one processor 110) may be operatively connected to at least one memory (storing at least one instruction) and may be configured to execute the at least one instruction to perform various functions described herein, for example, functions performed by elements shown in FIG. 3. The processor 110 (or the at least one processor 110) includes or corresponds to circuitry like a central processing unit (CPU), a microprocessor unit (MPU), an application processor (AP), a coprocessor (CP), a system-on-chip (SoC), or an integrated circuit (IC).

The wireless communication device 100 may transmit or receive frames through the processor 110, the RFIC 120, and the antennas 130. When the wireless communication device 100 transmits a frame, the wireless communication device 100 may operate as a transmitting device, and when the wireless communication device 100 receives a frame, the wireless communication device 100 may operate as a receiving device.

The processor 110 according to an embodiment compensates (or is configured to compensate) for phases of a first training symbol and a second training symbol following the first training symbol, based on a ‘reference CFO’ corresponding to one of subcarriers of a received frame in a time domain. The processor 110 calculates a ‘residual CFO’ for each of the subcarriers of the received frame, based on the reference CFO. The processor 110 compensates (or is configured to compensate) for phase differences between the first training symbol and the second training symbol for each of a plurality of subcarriers based on the residual CFOs in the frequency domain. In addition, after compensating for the phase differences between the first training symbol and the second training symbol based on the residual CFOs, the processor 110 estimates (or is configured to estimate) at least one of noise power and SNR, based on the first training symbol and the second training symbol.

The processor 110 according to an embodiment may determine (or may be configured to determine) a CFO corresponding to a center frequency of a channel of the received frame, as a reference CFO. The channel of the received frame refers to the entire frequency band in which the frame may be transmitted and received.

The processor 110 according to an embodiment may detect (or may be configured to detect) the bandwidth of the received frame. In addition, the processor 110 may determine (or may be configured to determine) the reference CFO based on the bandwidth of the received frame. For example, the processor 110 may determine a CFO corresponding to a center frequency of the bandwidth of the received frame, as the reference CFO. That is, the processor 110 may determine, as the reference CFO, the center frequency of the bandwidth in which the received frame is detected, rather than the center frequency of the channel of the received frame. The processor 110 may calculate (or may be configured to calculate) the residual CFO for each of the subcarriers related to the bandwidth of the received frame. Accordingly, the processor 110 may minimize (or may be configured to minimize) inter-subcarrier interference (ICI) in the process of estimating noise power and SNR.

According to an embodiment, after compensating for the phases of the first training symbol and the second training symbol in the time domain based on the reference CFO, the processor 110 may convert the first training symbol and the second training symbol into signals in a frequency domain.

According to an embodiment, the processor 110 may compensate for the phase of the second training symbol based on the residual CFO for each of a plurality of subcarriers, thereby compensating for the phase differences between the first training symbol and the second training symbol for each of the subcarriers. That is, the processor 110 may maintain repeatability of two consecutive symbols by compensating the phase of one symbol among the two consecutive symbols. According to another embodiment, the processor 110 may compensate for the phase of the first training symbol based on the residual CFO for each of the subcarriers, thereby compensating for the phase differences between the first training symbol and the second training symbol for each of the subcarriers.

According to an embodiment, the processor 110 may estimate at least one of the noise power and SNR, based on a size of the sum of the first training symbol and the second training symbol and a size of the difference between the first training symbol and the second training symbol in the frequency domain.

The wireless communication device 100 according to the disclosure may estimate noise power and SNR by considering both the CFO and the SCO. That is, the wireless communication device 100 may consider that subcarriers of a frame have different CFO deviations.

The wireless communication device 100 according to an embodiment may accurately estimate noise power and SNR by using training symbols that maintain repeatability (or that are repeated).

The wireless communication device 100 according to an embodiment may minimize inter-carrier interference (ICI) in the process of estimating noise power and SNR.

The wireless communication device 100 according to an embodiment may restore repetitive characteristics of consecutive training symbols regardless of bandwidth and frequency position of a received signal.

FIG. 3 is a block diagram of a wireless communication device 200 according to an embodiment.

Referring to FIG. 3, the wireless communication device 200 according to an embodiment includes a compensator 210, a fast Fourier transform (FFT) module 220, an SNR estimator 230, a bandwidth detector 240, a frequency offset estimator 250, and a CFO calculator 260.

In some embodiments, the compensator 210, the FFT module 220, the SNR estimator 230, the bandwidth detector 240, the frequency offset estimator 250, and the CFO calculator 260 may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein). These elements of FIG. 3 may, for example, be embodied in one or more semiconductor chips, or on substrate supports such as printed circuit boards and the like. These elements of FIG. 3 may be implemented by dedicated hardware, or performed by a processor (e.g., one or more programmed microprocessors and associated circuitry, or the processor 110 of FIG. 2), or by a combination of dedicated hardware to perform some functions of the block and a processor to perform other functions. Each of these elements may be physically separated into two or more interacting and discrete blocks. Likewise, these elements may be physically combined into more complex blocks.

The wireless communication device 200 may further include hardware circuits and/or software codes for transmitting and receiving frames.

In the time domain, the compensator 210 compensates for phases of a first training symbol and a second training symbol following the first training symbol, based on a reference CFO corresponding to one of subcarriers of a received frame.

The CFO calculator 260 determines the reference CFO and determines residual CFOs for each of the subcarriers of the received frame based on the reference CFO. According to an embodiment, the CFO calculator 260 may determine, as the reference CFO, a CFO corresponding to a center frequency of a channel of the received frame. According to another embodiment, the bandwidth detector 240 may detect a bandwidth of the received frame, and the CFO calculator 260 may determine the reference CFO based on a bandwidth of the received frame. For example, the CFO calculator 260 may determine, as the reference CFO, a CFO corresponding to the center frequency of the bandwidth of the received frame. In addition, the CFO calculator 260 may calculate the residual CFOs for each of the subcarriers related to the bandwidth of the received frame.

The compensator 210 compensates for phase differences between the first training symbol and the second training symbol for each of a plurality of subcarriers based on the residual CFOs in the frequency domain.

The SNR estimator 230 estimates at least one of noise power and SNR of the received frame, based on the first training symbol and the second training symbol. In detail, after the compensator 210 compensates for phase differences of the first training symbol and the second training symbol based on the residual CFOs, the SNR estimator 230 estimates at least one of noise power and SNR.

After, based on the reference CFO, the compensator 210 compensates for the phases of the first training symbol and the second training symbol in the time domain, the FFT module 220 may convert the first training symbol and the second training symbol into signals in the frequency domain.

According to an embodiment, the compensator 210 may compensate for the phase of the second training symbol based on the residual CFO, thereby compensating for the phase differences between the first training symbol and the second training symbol for each of the subcarriers.

According to an embodiment, the SNR estimator 230 may estimate at least one of the noise power and SNR, based on a size of the sum of the first training symbol and the second training symbol and a size of the difference between the first training symbol and the second training symbol in the frequency domain.

According to an embodiment, the frequency offset estimator 250 may estimate a frequency offset of the received frame. In addition, the frequency offset estimator 250 may transmit the frequency offset of the received frame to the compensator 210. The CFO calculator 260 may determine a reference CFO corresponding to one of the subcarriers of the received frame, based on the frequency offset of the received frame. In addition, the CFO calculator 260 may determine the reference CFO, based on the bandwidth of the received frame and the frequency offset of the received frame.

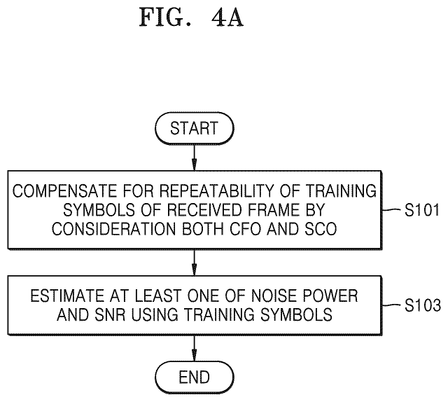

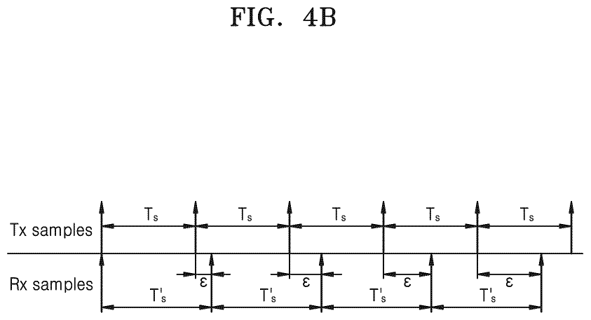

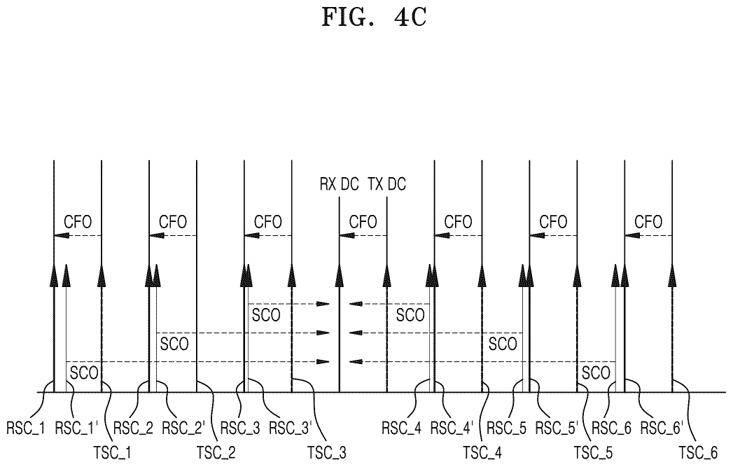

FIG. 4A is a flowchart illustrating an operation sequence of the wireless communication device 100 according to an embodiment. FIG. 4B is a diagram illustrating a sampling clock offset. FIG. 4C illustrates a CFO and an SCO in the frequency domain. FIGS. 4A to 4C may be described with reference to FIG. 2.

Referring to FIG. 4A, in operation S101, the wireless communication device 100 may compensate for the repeatability of training symbols of the received frame by considering both the CFO and the SCO. Embodiments in which the wireless communication device 100 adjusts training symbols in consideration of the CFO and the SCO may be described in other drawings.

In operation S103, the wireless communication device 100 may estimate at least one of the noise power and the SNR using the training symbols. In detail, the wireless communication device 100 may adjust training symbols (including a training sequence) by considering both the CFO and the SCO and may estimate at least one of the noise power and the SNR using the training symbols that maintain the repeatability. Accordingly, the wireless communication device 100 may accurately estimate at least one of the noise power and the SNR. The wireless communication device 100 may use at least one of the noise power and the SNR to demodulate and decode data.

A frequency offset generally exists between transmitting and receiving devices due to a mismatch in local oscillator (LO) clocks, and the frequency offset may be expressed in units of parts per million (ppm). A size (f_{CFO}) of the CFO of the received signal depends on a center frequency f_{c} of a wideband channel in which the receiving device operates, and may be expressed (in units of Hz) as below:

$${f}_{CFO} = {f}_{c} \cdot ( \frac{{FO}_{( ppm )}}{{10}^{6}} ) \qquad [ Equation 1 ]$$

An offset occurs in a sampling rate at which analog-to-digital signal conversion is made between transmission and reception due to a frequency offset FO₍ₚₚₘ₎.

Referring to FIG. 4B, a sampling period (Tx Samples) of the transmitting device is Tₛ, and a sampling period (Rx samples) of the receiving device is Tₛ′. Tₛ and Tₛ′ have a difference of ε.

The difference is referred to as an SCO or a sampling frequency offset (SFO). The size of the SCO depends on a bandwidth of a channel in which the receiving device operates, and may be expressed (in Hz frequency units) as follows:

$${f}_{CFO} = \frac{1}{{T}_{s}} - \frac{1}{{T}_{s}^{′}} = {f}_{BW} - {f}_{BW}^{′} = BW \cdot ( \frac{{FO}_{( ppm )}}{{10}^{6}} ) \qquad [ Equation 2 ]$$

Tₛ and Tₛ′ represent a sampling period at each transmitting and receiving end, and f_{BW} and f′_{BW} are the reciprocals, which respectively refer to the sampling frequencies and bandwidths of the transmitting and receiving ends. In this manner, when SCO exists, the bandwidths by the transmitting and receiving devices in the frequency domain are different, so there may be a difference in subcarrier spacing. When the wideband channel in which the receiving device operates includes a total N number of subcarriers, a deviation Δf_{subcarrier} of subcarrier spacing due to the SCO is:

$$Δ {f}_{subcarrier} = \frac{1}{N \cdot {T}_{s}} - \frac{1}{N \cdot {T}_{s}^{′}} = \frac{1}{N} ( {f}_{s , BW} - {f}_{s , BW}^{′} ) = \frac{{f}_{SCO}}{N} \qquad [ Equation 3 ]$$

The actual degree of CFO experienced by the wireless communication device 100 (FIG. 2) from the received signal has a deviation from f_{CFO} as much as Δf_subcarrier accumulated according to a distance from the center frequency for each subcarrier in the frequency domain.

Referring to FIG. 4C, when there is no SCO-coupled effect, the first subcarrier TSC_1 for a transmission signal has a difference equal to CFO with a first subcarrier RSC_1 recognized by the receiving device. Similarly, when there is no SCO-coupled effect, a second subcarrier TSC_2 for the transmission signal has a difference equal to CFO with a second subcarrier RSC_2 recognized by the receiving device. In this manner, when there is no SCO-coupled effect, each of third to sixth subcarriers TSC_3 to TSC_6 for the transmission signal has a difference equal to CFO, respectively, from each of third to sixth subcarriers RSC_3 to RSC_6 recognized by the receiving device.

A frequency position of a first subcarrier RSC_1′ recognized by the receiving device ‘when there is SCO-coupled effect’ is different from a frequency position of the first subcarrier RSC_1 recognized by the receiving device ‘when there is no SCO-coupled effect,’ and the difference is based on a distance SCO_1 from the center frequency. That is, respective differences between frequency positions of the second to sixth subcarriers RSC_2′ to RSC_6′ recognized by the receiving device ‘when there is SCO-coupled effect’ and the frequency positions of the second to sixth subcarriers RSC_1 to RSC_6′ recognized by the receiving device ‘when there is no SCO-coupled effect’ may vary depending on respective distances SCO_2 to SCO_6 from the center frequency. For example, as the distance from the center frequency increases, the difference between the position of the subcarrier recognized by the receiving device ‘when there is an SCO-coupled effect’ and the position of the subcarrier recognized by the receiving device ‘when there is no SCO-coupled effect’ may increase.

If the frequency index of an individual subcarrier is k (k is an integer), subcarriers may be present in the range of −N/2≤k<N/2, and the center frequency corresponds to k=0. CFO deviations due to SCO appear to be different for each subcarrier according to a certain rule depending on positions away from the center frequency of the entire channel. An example of the certain rule is:

$$[ Equation 4 ]$$

$${f}_{CFO , k} = {f}_{CFO} + k \cdot Δ {f}_{subcarrier} = {f}_{CFO} + k \cdot \frac{{f}_{SCO}}{N} = {f}_{c} \cdot ( \frac{{FO}_{( ppm )}}{{10}^{6}} ) + k \cdot \frac{BW}{N} \cdot ( \frac{{FO}_{( ppm )}}{{10}^{6}} ) = ( {f}_{c} + k \cdot \frac{BW}{N} ) \cdot ( \frac{{FO}_{( ppm )}}{{10}^{6}} )$$

In Equation 4, f_{CFO, k} refers to the size of CFO of a subcarrier located at index k. The size of the CFO of the subcarrier is expressed (in ppm) as follows:

$${f}_{CFO , k ( ppm )} = \frac{{f}_{CFO , k}}{{f}_{c}} \cdot {10}^{6} = ( 1 + \frac{BW}{{f}_{c}} \cdot \frac{k}{N} ) \cdot {FO}_{( ppm )} \qquad [ Equation 5 ]$$

Both CFO(f_{CFO}) and SCO(f_{SCO}) are associated with the frequency offset FO₍ₚₚₘ₎ due to LO mismatch between the transmitting and receiving devices, the degree f_{CFO, k} of CFO experienced at a certain subcarrier position k is proportional to the frequency offset (FO₍ₚₚₘ₎) and appears to linearly increase or decrease as a linear function for the frequency index k.

The wireless communication device 100 may detect a preamble of a frame and estimate a frequency offset to perform synchronization. The preamble may include a training sequence in which a sample having a certain length is periodically repeated in the time domain. The wireless communication device 100 may detect a received signal using the preamble and perform frequency offset estimation.

The CFO size (\hat{f}_{CFO, k}), which is expressed by the wireless communication device 100 for each subcarrier in a channel using the estimated frequency offset ( [symbol] ₍ₚₚₘ₎), may be estimated as expressed by Equation 6 below using a relational expression for the SCO linkage effect described above:

$${\hat{f}}_{CFO , k} = ( {f}_{c} + k \cdot \frac{BW}{N} ) \cdot ( \frac{{( ppm )}_{}}{{10}^{6}} ) \qquad [ Equation 6 ]$$

$${\hat{f}}_{CFO , k ( ppm )} = ( 1 + \frac{BW}{{f}_{c}} \cdot \frac{k}{N} ) \cdot {( ppm )}_{}$$

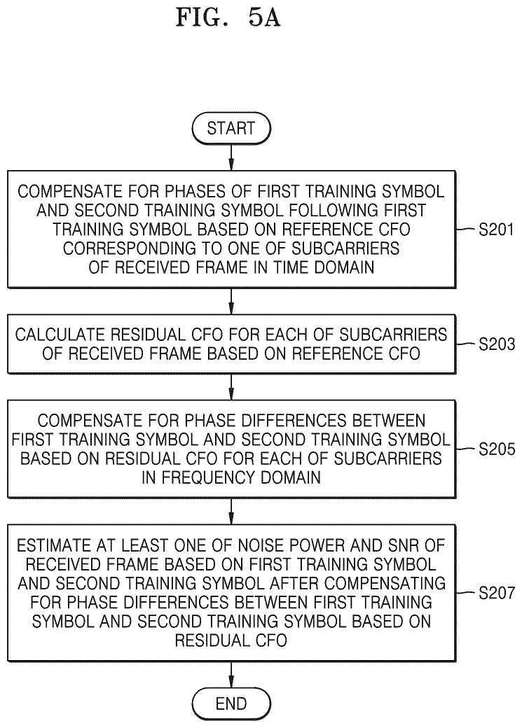

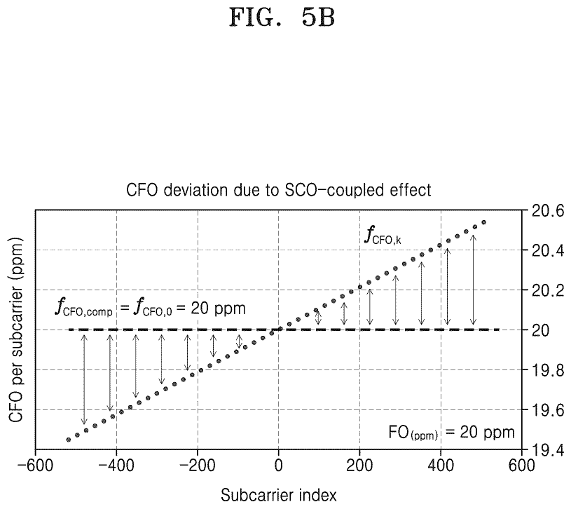

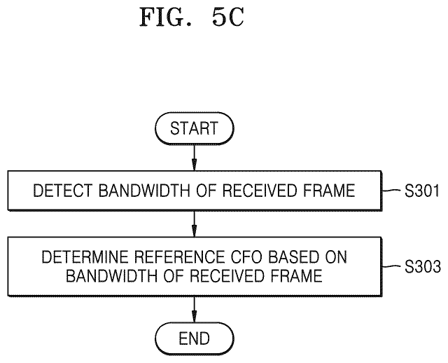

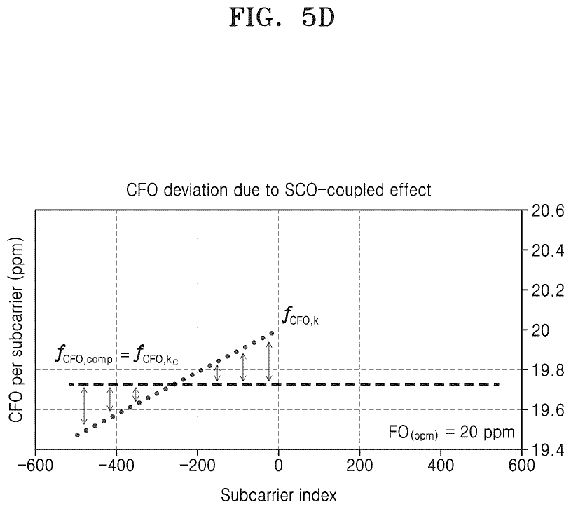

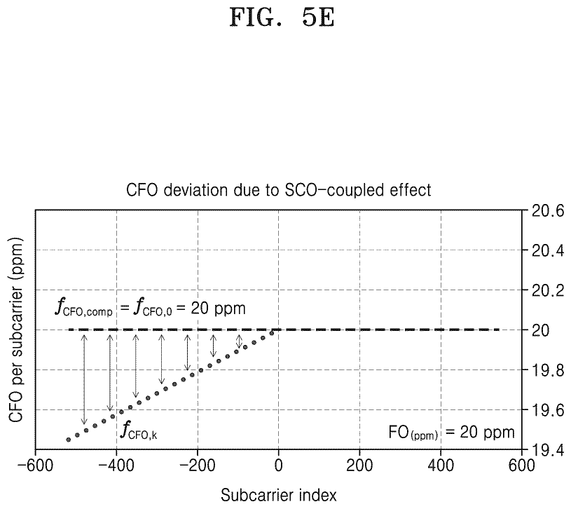

FIG. 5A is a flowchart illustrating an operation sequence of the wireless communication device 100 according to an embodiment. FIG. 5B is a graph illustrating a CFO, a reference CFO, and a residual CFO according to subcarrier indexes. FIG. 5C illustrates an operation sequence for determining a reference CFO based on a bandwidth of a received frame. FIGS. 5D and 5E illustrate graphs related to embodiments of determining a reference CFO based on a bandwidth of a received frame. FIGS. 5A and 5B may be described with reference to FIGS. 2 and 3.

Referring to FIG. 5A, in operation S201, the wireless communication device 100 may compensate for phases of a first training symbol and a second training symbol following the first training symbol, based on a reference CFO corresponding to one of a plurality of subcarriers of a received frame in the time domain. After compensating for the phases of the first training symbol and the second training symbol in the time domain based on the reference CFO, the wireless communication device 100 may convert the first training symbol and the second training symbol into signals in the frequency domain.

In operation S203, the wireless communication device 100 may calculate residual CFOs for each of the subcarriers of the received frame based on the reference CFO. Referring to FIG. 5B, according to an embodiment, a received signal having a bandwidth of 320 MHz in a wideband channel has a frequency offset (FO₍ₚₚₘ₎)=20 ppm. The CFO value (F_{CFO, k}) appears in the form of a linear deviation along the subcarrier indexes based on 20 ppm at the center frequency. As shown in FIG. 5B, the wireless communication device 100 may determine, as CFO (f_{CFO,comp}), a CFO value (f_{CFO,0}) corresponding to the center frequency of the channel. A residual CFO (f_{rCFO, k}) of the subcarrier of index k has a value obtained by subtracting the reference CFO (f_{CFO,comp}) from the CFO value (F_{CFO, k}) corresponding to the subcarrier. That is, the wireless communication device 100 may calculate a residual CFO for each of the subcarriers by calculating the residual CFO value (F_{CFO, k}) as a difference of the CFO value (f_{rCFO, k}) corresponding to the subcarrier of the index k (k is an integer) from the reference CFO (f_{CFO,comp}).

In operation S205, the wireless communication device 100 may compensate for phase differences between the first training symbol and the second training symbol based on the residual CFOs for each of the plurality of subcarriers in the frequency domain. For example, the wireless communication device 100 may compensate for the phase differences between the first training symbol and the second training symbol by compensating for the phase of the second training symbol based on the residual CFO.

In operation S207, the wireless communication device 100 may estimate at least one of noise power and SNR of the received frame based on the first training symbol and the second training symbol, after compensating for the phase differences between the first training symbol and the second training symbol based on the residual CFO. For example, the wireless communication device 100 may estimate at least one of the noise power and the SNR, based on a size of the sum of the first training symbol and the second training symbol and a size of the difference between the first training symbol and the second training symbol in the frequency domain.

The wireless communication device 100 may determine the reference CFO before compensating for the phases of the first training symbol and the second training symbol following the first training symbol, based on the reference CFO.

According to an embodiment, referring to FIG. 5B, the wireless communication device 100 may determine, as the reference CFO, the CFO value (f_{CFO,0}) corresponding to the center frequency of the channel, for example, regardless of a bandwidth of the received frame.

According to another embodiment, referring to FIGS. 5C and 5D, in operation S301, the wireless communication device 100 may detect the bandwidth of the received frame. As an example, FIG. 5D illustrates a frame received with a bandwidth occupying a lower 160 MHz of a 320 MHz-wideband channel and a frequency offset (FO₍ₚₚₘ₎)=20 ppm. The CFO value (F_{CFO, k}) of each subcarrier appears in the form of a linear deviation along the subcarrier indexes based on the center of the entire channel. The wireless communication device 100 may detect the bandwidth occupying the lower 160 MHz as the bandwidth of the received frame.

In operation S303 of FIG. 5C, the wireless communication device 100 may determine the reference CFO based on the detected bandwidth. For example, the wireless communication device 100 may determine a CFO value (f_{CFO,k}_{_{c}} ) corresponding to a subcarrier (k_{c}), as the reference CFO (f_{CFO,comp}). In this case, the size of the residual CFO value (f_{rCFO, k}) experienced by subcarriers is smaller than that in FIG. 5C. In other words, when the wireless communication device 100 determines, as the reference CFO (f_{CFO,comp}), the CFO value (f_{CFO,k}_{_{c}}) corresponding to the subcarrier (k_{c}) at the center of the detected bandwidth and performs compensation in the time domain, the size of the residual CFO (f_{rCFO, k}) experienced by the subcarrier components of the received signal may be reduced. Accordingly, inter-carrier interference (ICI) may be reduced. In addition, the wireless communication device 100 may calculate residual CFOs for each of the subcarriers related to the bandwidth of the received frame. In detail, the wireless communication device 100 may calculate the residual CFO for subcarriers of the bandwidth occupying the lower 160 MHz. The wireless communication device 100 may calculate the residual CFO corresponding to the subcarriers of the detected bandwidth, rather than the residual CFO corresponding to the subcarriers of the entire channel, thereby reducing the amount of calculation.

Referring to FIG. 5E, according to an embodiment, the wireless communication device 100 may detect the bandwidth occupying the lower 160 MHz of a 320 MHz wideband channel. Also, the wireless communication device 100 may determine, as the reference CFO (f_{CFO,comp}), the CFO value (f_{CFO,0}) corresponding to the center frequency of the channel.

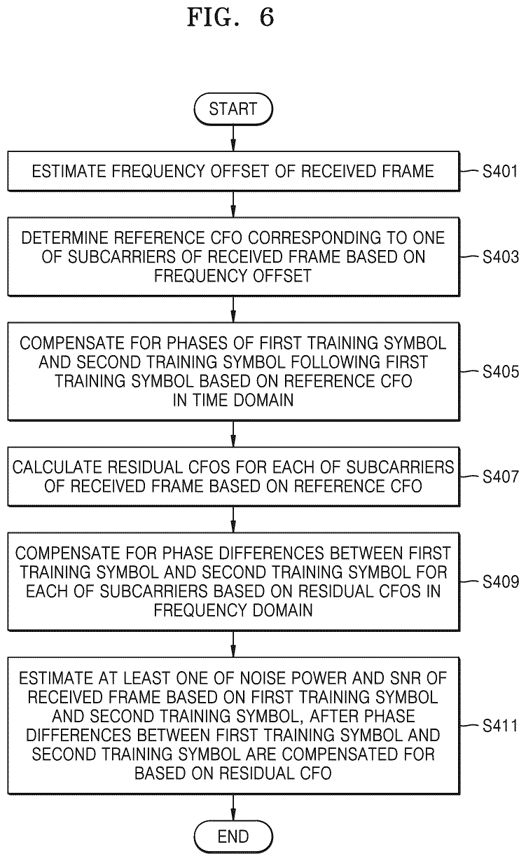

FIG. 6 is a flowchart illustrating an operation sequence of the wireless communication device 100 according to an embodiment. FIG. 6 may be described with reference to FIGS. 2 and 3.

Referring to FIG. 6, in operation S401, the wireless communication device 100 may estimate a frequency offset of the received frame.

In operation S403, the wireless communication device 100 may determine a reference CFO corresponding to one of subcarriers of a received frame based on a frequency offset.

As an example, the wireless communication device 100 may determine as the reference CFO, a CFO corresponding to the center frequency of a channel of the received frame based on the frequency offset.

As another example, the wireless communication device 100 may detect a bandwidth of the received frame, and the wireless communication device 100 may determine the reference CFO based on the frequency offset and a bandwidth of the received frame. For example, the wireless communication device 100 may determine, as a reference CFO, the CFO corresponding to the center frequency of the bandwidth of the received frame.

In operation S405, the wireless communication device 100 may compensate for the phases of the first training symbol and the second training symbol following the first training symbol based on the reference CFO in the time domain.

In operation S407, the wireless communication device 100 may calculate residual CFOs for each subcarrier of the received frame based on the reference CFO.

In operation S409, the wireless communication device 100 may compensate for phase differences between the first training symbol and the second training symbol for each of the plurality of subcarriers based on the residual CFOs in the frequency domain.

In operation S411, the wireless communication device 100 may estimate at least one of noise power and SNR of the received frame based on the first training symbol and the second training symbol after compensating for the phase differences between the first training symbol and the second training symbol based on the residual CFO.

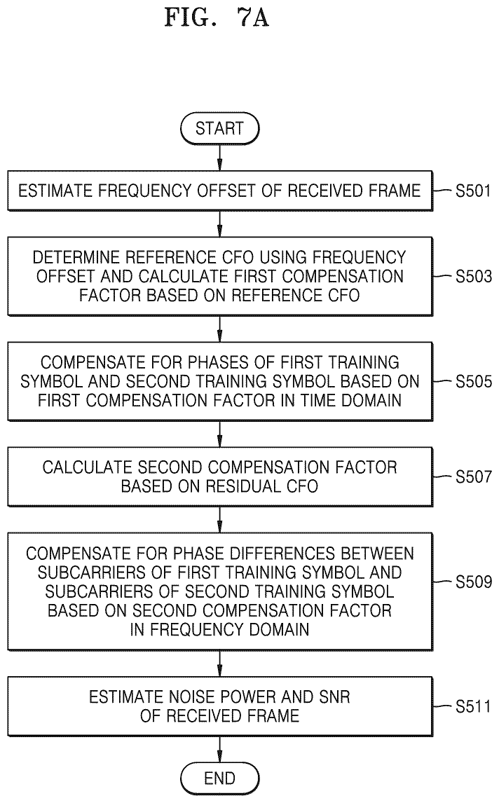

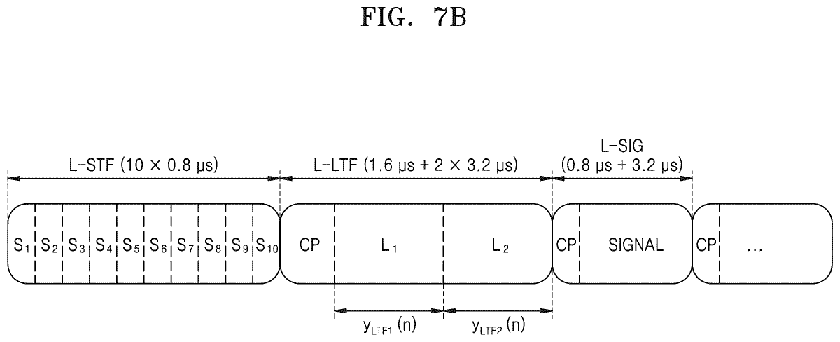

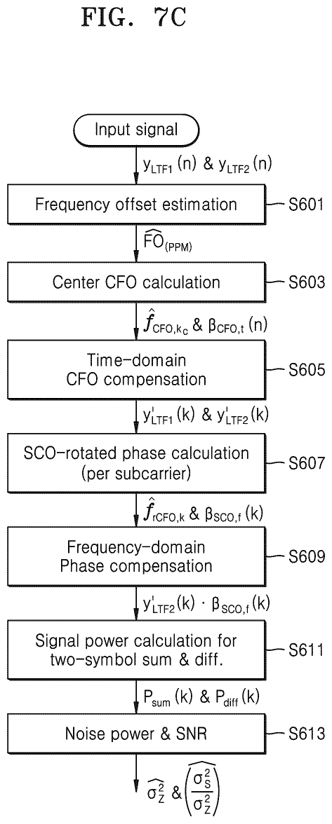

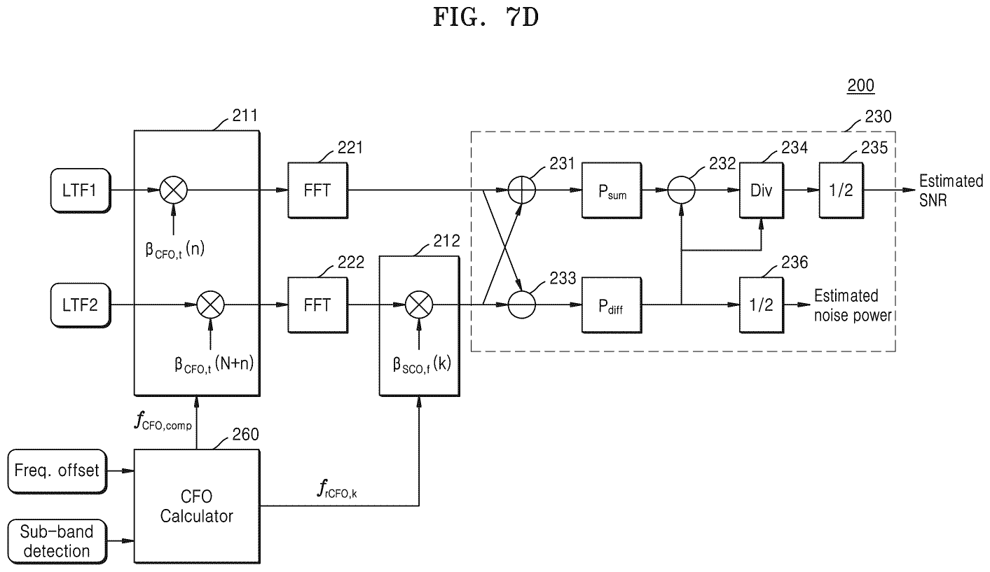

FIG. 7A is a flowchart illustrating an operation sequence of a wireless communication device according to an embodiment. FIG. 7A may be described with reference to FIGS. 2 and 3. FIG. 7B illustrates an example of a preamble structure of a wireless LAN frame. FIG. 7B may be described with reference to FIGS. 2 and 3.

Referring to FIG. 7A, in operation S501, the wireless communication device 100 may estimate a frequency offset of a received frame.

In operation S503, the wireless communication device 100 may determine a reference CFO using the frequency offset and calculate a first compensation factor based on the reference CFO.

In operation S505, the wireless communication device 100 may compensate for phases of a first training symbol and a second training symbol based on the first compensation factor in the time domain.

Referring to FIG. 7B, for example, in an IEEE 802.11 standard-based WLAN system, the wireless communication device 100 performs signal detection and synchronization using a preamble before a data symbol is received. In addition, the wireless communication device 100 may also estimate noise power and SNR using the preamble.

Referring to FIG. 7B, the preamble includes a short training field (STF), a long training field (LTF), and a signal (SIG) field. The LTF may include a first training symbol L1 and a second training symbol L2. The first training symbol L1 and the second training symbol L2 have the same sample array having a constant length N. The first training symbol L1 and the second training symbol L2 may be arranged consecutively, so that the sample array having the constant length N may be repeated twice in the time domain.

The first training symbol and the second training symbol may be expressed as follows:

$${Y}_{LTF 1} ( k ) = S ( k ) + {Z}_{1} ( k ) \qquad [ Equation 7 ]$$

$${Y}_{LTF 2} ( k ) = S ( k ) + {Z}_{2} ( k )$$

Y_{LTF1}(k) denotes the first training symbol, and Y_{LTF2}(k) denotes the second training symbol. k denotes a subcarrier index. S(k) is the same training sequence including N (N is a positive integer) samples. Z₁(k) and Z₁(k) each denote noise. The wireless communication device 100 according to the disclosure may maintain repeatability of the sample array having the constant length N by adjusting the phase of training symbols in consideration of the effects of CFO and SCO. That is, the wireless communication device 100 may consider the effect of rotating the phase differently for each subcarrier and may compensate for a phase change in two stages (in the time domain and frequency domain). Accordingly, the phase difference between consecutive training symbols may be canceled out and the repeatability of the signal may be maintained, thereby accurately estimating noise power and SNR.

In an embodiment, a CFO deviation of subcarriers caused by the interlocking effect of CFO and SCO has a certain rule, based on a distance from the center frequency of the entire channel. An example of the certain rule may be:

$${f}_{CFO , k} = {f}_{CFO , 0} + k \cdot \frac{{f}_{SCO}}{N} = ( a + bk ) \cdot \frac{{FO}_{( ppm )}}{{10}^{6}} \qquad [ Equation 8 ]$$

In Equation 8, a and b are constants depending on a system environment. Both the CFO value (f_{CFO,0}) and SCO value (f_{SCO}) corresponding to the center frequency of the entire channel are proportional to the frequency offset (FO₍ₚₚₘ₎), so the size (F_{CFO, k}) of CFO of a certain subcarrier position k is proportional to FO₍ₚₚₘ₎ and appears to linearly increase or decrease for the frequency index k. The wireless communication device 100 may estimate CFO (F_{CFO, k}) corresponding to the certain subcarrier k by substituting the frequency offset (FO₍ₚₚₘ₎) estimated in the synchronization process of the received signal.

The wireless communication device 100 may determine the reference CFO (f_{CFO,comp}) to compensate for phase rotation of the samples in the time domain. As an example, the wireless communication device 100 may determine, as the reference CFO(f_{CFO,comp}), the CFO (f_{CFO,0}) value corresponding to the center frequency k=0 in the channel. A first compensation factor in the time domain may be expressed as follows and has the effect of rotating the phase of the received sample in reverse along a time axis index n:

$${β}_{CFO , t} ( n ) = {e}^{- j 2 π {f}_{CFO , 0} ( \frac{n}{b \cdot N} )} \qquad [ Equation 9 ]$$

In Equation 9, β_{CFO,t}(n) denotes the first compensation factor in the time domain.

Referring back to FIG. 7A, in operation S507, the wireless communication device 100 may calculate a second compensation factor based on the residual CFO. When the wireless communication device 100 applies the first compensation factor to two consecutive training sequence symbols in the time domain, the size f_{rCFO, k} of the residual CFO in the subcarrier k of the received signal is as follows:

$$[ Equation 10 ]$$

$${f}_{rCFO , k} = {f}_{CFO , k} - {f}_{CFO , comp} = {f}_{CFO , k} - {f}_{CFO , 0} = k \cdot \frac{{f}_{SCO}}{N} = bk \cdot \frac{{FO}_{( ppm )}}{{10}^{6}}$$

The residual CHO rotates phase over time, so a phase difference having a certain size may occur for each subcarrier between two consecutive training symbols having N sample periods as follows:

$$Δ {θ}_{k} = 2 π {f}_{rCFO , k} \cdot ( \frac{N}{b \cdot N} ) = 2 π k ( \frac{{FO}_{( ppm )}}{{10}^{6}} ) \qquad [ Equation 11 ]$$

In Equation 11, Δθₖ denotes a phase difference between the first training symbol and the second training symbol.

The wireless communication device 100 may maintain repeatability of the two consecutive training symbols by compensating for the phase difference for each subcarrier of the second training symbol. For the certain subcarrier k, the second compensation factor in the frequency domain is expressed as follows:

$${β}_{SCO , f} ( k ) = {e}^{- j Δ {θ}_{k}} = {e}^{- j 2 π k ( \frac{{FO}_{( ppm )}}{{10}^{6}} )} \qquad [ Equation 12 ]$$

In Equation 12, β_{SCO,f}(k) is the second compensation factor in the frequency domain.

In operation S509, the wireless communication device 100 may compensate for phase differences between subcarriers of the first training symbol and subcarriers of the second training symbol based on the second compensation factor in the frequency domain.

For the second training symbol whose CFO has been compensated in the time domain, the wireless communication device 100 may apply the second phase compensation factor (β_{SCO,f}(k)) to each subcarrier to thereby remove the phase difference between the consecutive first training symbol and the second training symbol and preserve the repeatability of the training sequence as follows:

$$ℱ ( {y}_{LTF 1} ( n ) \cdot {β}_{CFO , t} ( n ) ) = {Y}_{LTF 1}^{′} ( k ) = {S}^{′} ( k ) + {Z}_{1} ( k ) \qquad [ Equation 13 ]$$

$${β}_{SCO , f} ( k ) \cdot ℱ ( {y}_{LTF 2} ( n ) \cdot {β}_{CFO , t} ( N + n ) ) = {Y}_{LTF 2}^{′} ( k ) = {S}^{′} ( k ) + {Z}_{2} ( k )$$

In operation S511, the wireless communication device 100 may estimate noise power and SNR of the received frame.

The wireless communication device 100 may estimate noise power and SNR using the repeatability of the first training symbol and the second training symbol. The wireless communication device 100 may estimate noise power and SNR based on the size of the sum of the first training symbol and the second training symbol and the size of the difference between the first training symbol and the second training symbol in the frequency domain.

The sum of the subcarriers of the first training symbol and the subcarriers of the second training symbol may be expressed as below:

$$[ Equation 14 ]$$

$${P}_{sum} ( k ) = \frac{{\sum }_{k = 0}^{N - 1} {\vert {Y}_{LTF 1}^{′} ( k ) + {Y}_{LTF 2}^{″} ( k ) \vert}^{2}}{N} ≅ \frac{{\sum }_{k = 0}^{N - 1} \{ 4 {\vert {S}^{′} ( k ) \vert}^{2} + {\vert {Z}_{1} ( k ) \vert}^{2} + {\vert {Z}_{2} ( k ) \vert}^{2} \}}{N} ≅ 4 {σ}_{S}^{2} + 2 {σ}_{Z}^{2}$$

In Equation 14, Pₛᵤₘ(k) is the sum of the subcarriers of the first training symbol and the subcarriers of the second training symbol. Y′_{LTF1}(k) denotes a k-th subcarrier of the first training symbol compensated in the time domain. Y″_{LTF2}(k) denotes a k-th subcarrier of the second training symbol compensated in the frequency domain after being compensated in the time domain. Although not expressed in Equation 14, Y′_{LTF2}(k) denotes the k-th subcarrier of the second training symbol compensated in the time domain.

The difference between the subcarriers of the first training symbol and the subcarriers of the second training symbol may be expressed below:

$$[ Equation 15 ]$$

$${P}_{diff} ( k ) = \frac{{\sum }_{k = 0}^{N - 1} {\vert {Y}_{LTF 1}^{′} ( k ) + {Y}_{LTF 2}^{″} ( k ) \vert}^{2}}{N} ≅ \frac{{\sum }_{k = 0}^{N - 1} \{ {\vert {Z}_{1} ( k ) \vert}^{2} + {\vert {Z}_{2} ( k ) \vert}^{2} \}}{N} ≅ 2 {σ}_{Z}^{2}$$

In Equation 15, P_{diff}(k) is the difference between the subcarriers of the first training symbol and the subcarriers of the second training symbol. Y′_{LTF1}(k) denotes the k-th subcarrier of the first training symbol compensated in the time domain. Y″_{LTF2}(k) denotes the k-th subcarrier of the second training symbol compensated in the frequency domain after being compensated in the time domain. Although not expressed in Equation 15, Y′_{LTF2}(k) denotes the k-th subcarrier of the second training symbol compensated in the time domain.

The estimated noise power may be expressed as below:

$$= \frac{{P}_{diff} ( k )}{2} \qquad [ Equation 16 ]$$

In Equation 16, [symbol] denotes the estimated noise power.

The estimated SNR may be expressed below:

$$( \frac{{σ}_{Z}^{2}}{} ) = \frac{{P}_{sum} ( k ) - {P}_{diff} ( k )}{2 {P}_{diff} ( k )} \qquad [ Equation 17 ]$$

In Equation 17,

denotes the estimated SNR.

When the wireless communication device 100 determines, as the reference CFT, the CFO corresponding to the center frequency k_{c} of the bandwidth in which a frame is actually is transmitted, instead of the center frequency of the channel, the first compensation factor and the second compensation factor may be expressed as Equation 17 and Equation 18, respectively, as follows:

$${β}_{CFO , t} ( n ) = {e}^{- j 2 π {f}_{CFO , {k}_{c}} ( \frac{n}{b \cdot N} )} \qquad [ Equation 17 ]$$

$${β}_{SCO , f} ( k ) = {e}^{- j {Δθ}_{k}} = {e}^{- j 2 π ( k - {k}_{c} )} ( \frac{{FO}_{( ppm )}}{{10}^{6}} ) \qquad [ Equation 18 ]$$

FIG. 7C is a flowchart illustrating an operation sequence of the wireless communication device 100 according to an embodiment. FIG. 7C may be described with reference to FIGS. 2 and 3.

Referring to FIG. 7C, the wireless communication device 100 may estimate a frequency offset in operation S601. The wireless communication device 100 may receive a first training symbol y_{LTF1}(n) and a second training symbol y_{LTF1}(n) and estimate a frequency offset using the first training symbol y_{LTF1}(n) and the second training symbol y_{LTF1}(n).

In operation S603, the wireless communication device 100 may calculate a center CFO using the estimated frequency offset ( [symbol] ₍ₚₚₘ₎). In detail, the wireless communication device 100 may detect a bandwidth of the received frame and determine, as the reference CFO, a CFO (\hat{f}_{CFO, kc}) corresponding to the center frequency of the detected bandwidth. Also, the wireless communication device 100 may generate a first compensation factor (β_{CFO,t}(n)). In operation S605, the wireless communication device 100 may perform time domain CFO compensation. In detail, the wireless communication device 100 may perform phase compensation on the first training symbol (y_{LTF1}(n)) and the second training symbol (Y_{LTF2}(n)), based on the CFO (\hat{f}_{CFO, kc}) corresponding to the center frequency of the detected bandwidth and the first compensation factor (β_{CFO,t}(n)). In detail, y_{LTF1}(n) denotes the first training symbol compensated in the time domain. y_{LTF2}(n) denotes the second training symbol compensated in the time domain. In operation S607, the wireless communication device 100 may calculate the SCO-rotated phase. The wireless communication device 100 may calculate the residual CFO (f_{rCFO, k}) by considering the SCO-coupled effect. Also, the wireless communication device 100 may calculate a second compensation factor (β_{SCO,f}(k)). In operation S609, the wireless communication device 100 may compensate for the phase of the second training symbol (y′_{LTF2}(k)) using the second compensation factor (β_{SCO,f}(k)). The wireless communication device 100 may multiply the second training symbol (y′_{LTF2}(k)) by the second compensation factor (β_{SCO,f}(k)) to be compensated in the time domain and subsequently obtain the second training symbol (y″_{LTF2}(k)) compensated in the frequency domain. In operation S611, the wireless communication device 100 may calculate a sum (Pₛᵤₘ(k)) and difference (P_{diff}(k)) of signal strengths of the two symbols. In operation S613, the wireless communication device 100 may estimate noise power ( [symbol] ) and

$$SNR .$$

FIG. 7D is a block diagram of the wireless communication device 200 according to an embodiment. FIG. 7D may be described with reference to FIG. 3.

Referring to FIG. 7D, the compensator 210 may include compensators 211 and 212. The FFT module 220 may include a first FFT module 221 and a second FFT module 222. The SNR estimator 230 may include an adder 231, a first subtractor 232, a second subtractor 233, a divider 234, and constant multipliers 235 and 236.

The CFO calculator 260 may receive a frequency offset (Freq. offset) and a detected subband. The CFO calculator 260 may calculate at least one of a center frequency of a reception frame channel and a center frequency of a bandwidth of the detected subband, based on the frequency offset (Freq. offset) and the detected subband. The CFO calculator 260 may determine the reference CFO (f_{CFO,comp}) corresponding to the center frequency of the channel or the center frequency of the bandwidth. In addition, the CFO calculator 260 may calculate the residual CFOs (f_{rCFO, k}) based on at least one of the center frequency of the channel and the center frequency of the bandwidth of the detected subband. The CFO calculator 260 may transfer the reference CFO (f_{CFO,comp}) to the compensator 211. The compensator 211 may extract the first compensation factor (β_{CFO,t}(n)) from the reference CFO (f_{CFO,comp}) and may multiply the first training symbol LTF1 by the first compensation factor (β_{CFO,t}(n)) in the time domain. The compensator 211 may multiply the second training symbol LTF2 by the first compensation factor (β_{CFO,t}(N+n)) in the time domain. The first FFT module 221 may convert the first training symbol compensated in the time domain into the frequency domain. The second FFT module 222 may convert the second training symbol compensated in the time domain into the frequency domain. The compensator 212 may extract the second compensation factor (β_{SCO,f}(k)) from the residual CFOs (f_{rCFO, k}) and may multiply the second training symbol of the frequency domain received from the second FFT module 222 by the second compensation factor (β_{SCO,f}(k)) Accordingly, the repeatability of the first training symbol LTF1 and the second training symbol LTF2 may be maintained.

The adder 231 may add the intensity of the first training symbol compensated in the time domain to the intensity of the second training symbol compensated in the time domain and then compensated once again in the frequency domain, in the frequency domain, to generate a power sum (Psum).

The second subtractor 233 may obtain a difference between the intensity of the first training symbol compensated in the time domain and the intensity of the second training symbol compensated in the time domain and then compensated once again in the frequency domain, thereby generating a power difference (Pdiff). The first subtractor 232 may obtain a difference between the power sum (Psum) and the power difference (Pdiff). The divider 234 may divide the difference between the power sum (Psum) and the power difference (Pdiff) by the power difference (Pdiff). The constant multipliers 235 and 236 may multiply an input value by 0.5. The constant multiplier 235 may output an SNR estimate value, and the constant multiplier 236 may output an estimate value of noise power.

Assuming an ideal case in which only the CFO-coupled effect is considered and the SCO-coupled effect does not exist, the received sample of training symbols have a phase that rotates at a constant rate of change over time, so the training symbols may be expressed as follows:

$$\begin{matrix}{\dot{y}}_{LTF 1} ( n ) = {y}_{LTF 1} ( n ) {e}^{j 2 π ( \frac{{f}_{CFO}}{{f}_{subcarrier}} ) ( \frac{n}{N} )} ( 0 \leq n \leq N - 1 ) \\ {\dot{y}}_{LTF 2} ( n ) = {y}_{LTF 2} ( n ) {e}^{j 2 π ( \frac{{f}_{CFO}}{{f}_{subcarrier}} ) ( \frac{N + n}{N} )} ( 0 \leq n \leq N - 1 )\end{matrix} \qquad [ Equation 19 ]$$

In Equation 19, \dot{y}_{LTF1}(n) and \dot{y}_{LTF2}(n) are the first training symbol and the second training symbol recognized by the wireless communication device 200 in the time domain, respectively. The wireless communication device 200 may perform CFO compensation in a manner of estimating an accurate CFO value (f_{CFO}) and rotating the phase inversely over time. The frequency domain through FFT operation of each of the CFO-compensated first and second training symbols may be expressed as follows:

$$\begin{matrix}ℱ ( {\dot{y}}_{LTF 1} ( n ) {e}^{- j 2 π ( \frac{{f}_{CFO}}{{f}_{subcarrier}} ) ( \frac{n}{N} )} ) = ℱ ( {y}_{LTF 1} ( n ) ) = {Y}_{LTF 1} ( k ) = S ( k ) + {Z}_{1} ( k ) \\ ℱ ( {\dot{y}}_{LTF 2} ( n ) {e}^{- j 2 π ( \frac{{f}_{CFO}}{{f}_{subcarrier}} ) ( \frac{N + n}{N} )} ) = ℱ ( {y}_{LTF 2} ( n ) ) = {Y}_{LTF 2} ( k ) = S ( k ) + {Z}_{2} ( k )\end{matrix} \qquad [ Equation 20 ]$$

k∈[0, N−1] denotes a frequency index corresponding to N subcarriers in the channel. S(k) refers to a received signal including the channel between transmission and reception. Z₁(k) and Z₂(k) denote noise and interference signals applied to each of the first training symbol and the second training symbol. Here, an average signal strength of the received signal and noise components may be expressed as follows:

$$\begin{matrix}E \{ {\vert S ( k ) \vert}^{2} \} = {σ}_{S}^{2} \approx \frac{1}{N} {\sum }_{k = 0}^{N - 1} {\vert S ( k ) \vert}^{2} \\ E \{ {\vert Z ( k ) \vert}^{2} \} = {σ}_{Z}^{2} \approx \frac{1}{N} {\sum }_{k = 0}^{N - 1} {\vert {Z}_{1} ( k ) \vert}^{2} \approx \frac{1}{N} {\sum }_{k = 0}^{N - 1} {\vert Z ( k ) \vert}^{2}\end{matrix} \qquad [ Equation 21 ]$$

The wireless communication device 200 (a receiving end) may obtain the sum/difference for each subcarrier of the first training symbol and the second training symbol as follows:

$$\begin{matrix}{Y}_{LTF 1} ( k ) + {Y}_{LTF 2} ( k ) = 2 S ( k ) + {Z}_{1} ( k ) + {Z}_{2} ( k ) \\ {Y}_{LTF 1} ( k ) - {Y}_{LTF 2} ( k ) = {Z}_{1} ( k ) - {Z}_{2} ( k )\end{matrix} \qquad [ Equation 22 ]$$

The wireless communication device 200 may calculate the average signal strength of each sum/difference for the frequency components of the entire symbols and estimate the noise power (σ_{Z}²) and SNR (σ_{S}²/σ_{Z}²) using the calculated value.

A signal corresponding to a certain subcarrier index k∈[0, N−1] in the training symbol may be expressed as follows:

$${\ddot{y}}_{LTF 1 , k} ( n ) = {y}_{LTF 1 , k} ( n ) {e}^{j 2 π ( \frac{{f}_{CFO , 0}}{{f}_{subcarrier}} ) ( \frac{n}{N} )} = {y}_{LTF 1 , k} ( n ) {e}^{j 2 π ( \frac{k \cdot ( Δ {f}_{subcarrier} )}{{f}_{subcarrier}} ) ( \frac{n}{N} )} \qquad [ Equation 23 ]$$

$${\ddot{y}}_{LTF 2 , k} ( n ) = {y}_{LTF 2 , k} ( n ) {e}^{j 2 π ( \frac{{f}_{CFO , 0}}{{f}_{subcarrier}} ) ( \frac{N + n}{N} )} = {y}_{LTF 2 , k} ( n ) {e}^{j 2 π ( \frac{{f}_{CFO , 0} + k \cdot ( Δ {f}_{subcarrier} )}{{f}_{subcarrier}} ) ( \frac{N + n}{N} )}$$

In Equation 23, ÿ_{LTF1, k}(n) and ÿ_{LTF2, k}(n) denote the signal of the first training symbol and the signal of the second training symbol corresponding to the subcarrier index k∈[0, N−1], respectively.

The wireless communication device 200 first compensates for phase rotation due to the reference CFO by a certain size in the time domain and then compensates for additional phase rotation due to the SCO-coupled effect in the frequency domain. First, for CFO compensation in the time domain, when the CFO (f_{CFO,0}) corresponding to the center frequency k=0 within the channel is determined as the reference CFO, the first compensation factor may be generated as follows:

$${β}_{CFO , t} ( n ) = {e}^{- j 2 π ( \frac{{f}_{CFO , 0}}{{f}_{subcarrier}} ) ( \frac{n}{N} )} \qquad [ Equation 24 ]$$

By applying the first compensation factor to each of the consecutive first and second training symbols, the first and second training symbols may be expressed as Equation 25 and Equation 26 below, respectively:

$${y}_{LTF 1}^{′} ( n ) = {β}_{CFO , t} ( n ) \cdot \{ {\sum }_{k} {\ddot{y}}_{LTF 1 , k} ( n ) \} = {e}^{- j 2 π ( \frac{{f}_{CFO , 0}}{{f}_{subcarrier}} ) ( \frac{n}{N} )} \cdot \{ {\sum }_{k} {\ddot{y}}_{LTF 1 , k} ( n ) \} = {\sum }_{k} {y}_{LTF 1 , k} ( n ) {e}^{j 2 π ( \frac{k \cdot ( Δ {f}_{subcarrier} )}{{f}_{subcarrier}} ) ( \frac{n}{N} )} = {\sum }_{k} {y}_{LTF 1 , k} ( n ) {e}^{j 2 π ( \frac{{f}_{CFO , 0}}{{f}_{subcarrier}} ) ( \frac{n}{N} )} \qquad [ Equation 25 ]$$

$${y}_{LTF 2}^{′} ( n ) = {β}_{CFO , t} ( n ) \cdot \{ {\sum }_{k} {\ddot{y}}_{LTF 2 , k} ( n ) \} = {e}^{- j 2 π ( \frac{{f}_{CFO , 0}}{{f}_{subcarrier}} ) ( \frac{n}{N} )} \cdot \{ {\sum }_{k} {\ddot{y}}_{LTF 2 , k} ( n ) \} = {\sum }_{k} {y}_{LTF 2 , k} ( n ) {e}^{j 2 π ( \frac{k \cdot ( Δ {f}_{subcarrier} )}{{f}_{subcarrier}} ) ( \frac{n}{N} )} = {\sum }_{k} {y}_{LTF 2 , k} ( n ) {e}^{j 2 π ( \frac{{f}_{CFO , 0}}{{f}_{subcarrier}} ) ( \frac{n}{N} )} \qquad [ Equation 26 ]$$

In Equation 25 and Equation 26, y′_{LTF1}(n) and y′_{LTF2}(n) denote the first training symbol and the second training symbol to which the first compensation factor is applied, respectively.

The phases of the signals of the first training symbol and the second training symbol are rotated by the residual CFO (f_{rCFO, k}) of each subcarrier after the compensation in the time domain. The residual CFO (f_{rCFO, k}) may be expressed as follows:

$${f}_{rCFO , k} = {f}_{CFO , k} - {f}_{CFO , 0} = k \cdot ( {Δf}_{subcarrier} ) = k \cdot \frac{{f}_{SCO}}{N} = k \cdot \frac{BW}{N} \cdot \frac{{FO}_{( ppm )}}{{10}^{6}} \qquad [ Equation 27 ]$$

In this manner, the CFO of each subcarrier resulting from the effect of SCO may be not fully compensated in the time domain. If the wireless communication device 200 converts the training symbols, which may be not fully compensated, into the frequency domain through an FFT operation and uses the symbols in the frequency domain, inter-carrier interference (ICI) may occur.

Therefore, when the wireless communication device 200 multiplies each subcarrier of the second training symbol by the second compensation factor (β_{SCO,f}(k)) in the frequency domain, the phase difference between the first training symbol and the second training symbol may be removed and the first training symbol and the second training symbol may have the same training sequence. The second compensation factor and the second training symbol multiplied by the second compensation factor may be expressed as follows:

$${β}_{SCO , f} ( k ) = {e}^{- j 2 π ( \frac{{f}_{rCFO , k}}{{f}_{subcarrier}} )} = {e}^{- j 2 π ( \frac{k \cdot ( {f}_{SCO} / N )}{BW / N} )} = {e}^{- j 2 π k ( \frac{{FO}_{( ppm )}}{{10}^{6}} )} \qquad [ Equation 28 ]$$

$${Y}_{{LTF}_{2}}^{′} ( k ) \cdot {β}_{SCO , f} ( k ) = \tilde{S} ( k ) + {Z}_{2} ( k ) \cdot {e}^{- j 2 π ( \frac{{f}_{rCFO , k}}{{f}_{subcarrier}} )} = \tilde{S} ( k ) + {Z}_{2}^{′} ( k ) \qquad [ Equation 29 ]$$

y′_{LTF2}(n) denotes the second training symbol to which the first compensation factor is applied. In Equation 29, y′_{LTF2}(k) denotes the second training symbol to which the first compensation factor in the frequency domain is applied.

When the received signal has a bandwidth corresponding to some subbands of the channel, the received signal with the reference CFO compensated may be expressed as follows:

$${y}_{LTF}^{′} ( n ) = {e}^{- j 2 π ( \frac{{f}_{CFO , 0}}{{f}_{subcarrier}} ) ( \frac{n}{N} )} \cdot \{ {\sum }_{k ∈ D} {y}_{LTF , k}^{″} ( n ) \} = {\sum }_{k ∈ D} {y}_{LTF , k} ( n ) {e}^{j 2 π ( \frac{k \cdot ( Δ {f}_{subcarrier} )}{{f}_{subcarrier}} ) ( \frac{n}{N} )} \qquad [ Equation 30 ]$$

Equation 30 may be described with reference to the above-mentioned Equations. D denotes a subset of frequency components included in a subband in which a signal is detected among all subcarrier indices of the entire channel. As the value of the frequency index k∈D constituting the received signal increases, the residual CFO effect and inter-carrier interference (ICI) experienced by each subcarrier may increase. In order to reduce ICI, the wireless communication device 200 may compensate for the phase in the time domain using CFO (f_{CFO,kc}) at the center frequency index k_{c} based on the bandwidth of the received signal instead of the center frequency within the channel. Here, the compensation factor, residual CFO for each subcarrier, and compensated received signal may be expressed as follows:

$${\overline{β}}_{SCO , t} ( n ) = {e}^{- j 2 π ( \frac{{f}_{CFO} , {k}_{c}}{{f}_{subcarrier}} ) ( \frac{n}{N} )} \qquad [ Equation 31 ]$$

$${f}_{rCFO , k} = {f}_{CFO , k} - {f}_{CFO , {k}_{c}} = ( k - {k}_{c} ) \cdot ( Δ {f}_{subcarrier} ) = ( k - {k}_{c} ) \cdot \frac{{f}_{SCO}}{N} = ( k - {k}_{c} ) \cdot \frac{BW}{N} \cdot \frac{{FO}_{( ppm )}}{{10}^{6}} \qquad [ Equation 32 ]$$

$$\begin{matrix}{y}_{LTF} ( n ) = {e}^{- j 2 π ( \frac{{f}_{CFO} , {k}_{c}}{{f}_{subcarrier}} ) ( \frac{n}{N} )} \cdot \{ {\sum }_{k ∈ D} {y}_{LTF , k}^{″} ( n ) \} \\ = {\sum }_{k ∈ D} {y}_{LTF , k} ( n ) {e}^{j 2 π ( \frac{( {f}_{CFO , 0} - {f}_{CFO , {k}_{c}} ) + k \cdot ( Δ {f}_{subcarrier} )}{{f}_{subcarrier}} ) ( \frac{n}{N} )} \\ = {\sum }_{k ∈ D} {y}_{LTF , k} ( n ) {e}^{j 2 π ( \frac{( k - {k}_{c} ) \cdot Δ {f}_{subcarrier}}{{f}_{subcarrier}} ) ( \frac{n}{N} )}\end{matrix} \qquad [ Equation 33 ]$$

Equation 31 to Equation 33 may be described with reference to the Equations described above. y̅_{LTF}(n) denotes compensated received signal. Because the size of the residual CFO of each subcarrier after phase compensation in the time domain is proportional to (k−k_{c}), ICI due to the residual CFO for the frequency components (k∈D) of the received signal based on k_{c} may be reduced. Thereafter, the wireless communication device 200 may perform frequency domain conversion of the first and second training symbols and additional phase compensation for the second training symbol. The first training symbol and second training symbol converted into the frequency domain may be expressed as Equation 34 and Equation 35 below. The compensation factor and the second training symbol to which the compensation factor is applied may be expressed as Equation 36 and Equation 37:

$${\overline{Y}}_{{LTF}_{1}} ( k ) = ℱ ( {\overline{y}}_{{LTF}_{1}} ( n ) ) = {α}_{ICI}^{′} ( k ) \cdot S ( k ) + {Z}_{ICI}^{′} ( k ) + {Z}_{1} ( k ) = \overline{S} ( k ) + {Z}_{1} ( k ) \qquad [ Equation 34 ]$$

$${\overline{Y}}_{{LTF}_{2}} ( k ) = ℱ ( {y}_{{LTF}_{2}} ( n ) ) = \{ {α}_{ICI}^{′} ( k ) \cdot S ( k ) + {Z}_{ICI}^{′} ( k ) \} \cdot {e}^{j 2 π ( \frac{( k - {k}_{c} ) \cdot ( Δ {f}_{subcarrier} )}{{f}_{subcarrier}} )} + {Z}_{2} ( k ) \qquad [ Equation 35 ]$$

$${\overline{β}}_{SCO , f} ( k ) = {e}^{- j 2 π ( \frac{( k - {k}_{c} ) \cdot ( Δ {f}_{subcarrier} )}{{f}_{subcarrier}} )} = {e}^{- j 2 π ( \frac{( k - {k}_{c} ) \cdot ( {f}_{SCO} / N )}{BW / N} )} e {=}^{- j 2 π ( k - {k}_{c} ) ( \frac{{FO}_{( ppm )}}{{10}^{6}} )} \qquad [ Equation 36 ]$$

$${\overline{Y}}_{{LTF}_{2}} ( k ) \cdot {\overline{β}}_{SCO , f} ( k ) = \overline{S} ( k ) + {Z}_{2}^{′} ( k ) \qquad [ Equation 37 ]$$

Unlike the embodiment described above, the SNR estimator 230 may include an arithmetic processor, and the arithmetic processor may perform the operations described above.

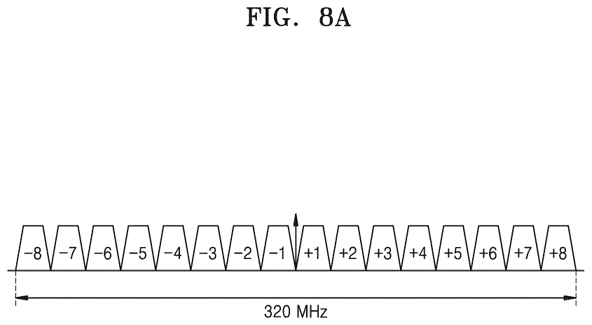

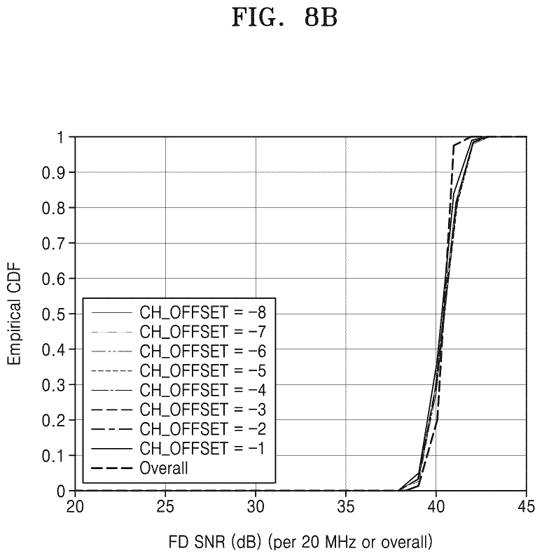

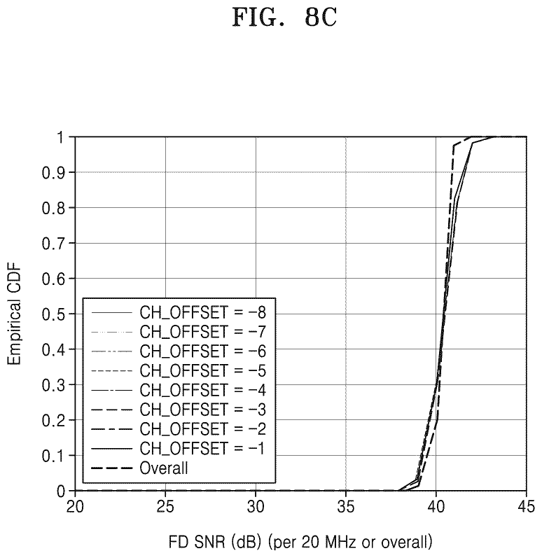

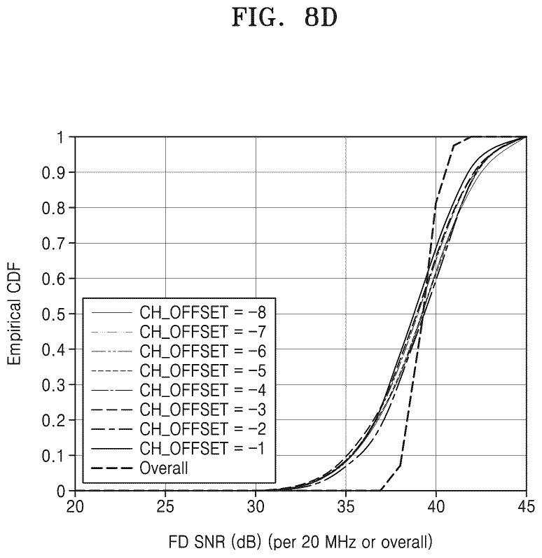

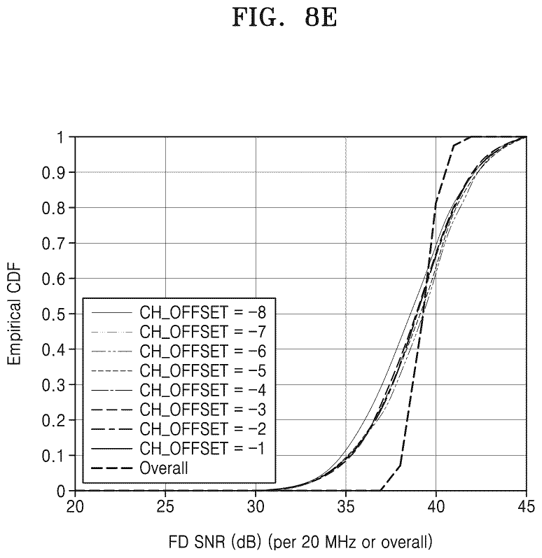

FIG. 8A illustrates a division of a channel of a received frame according to an embodiment. FIGS. 8B and 8C illustrate SNR estimated considering the SCO influence in an AWGN channel according to an embodiment. FIGS. 8D and 8E illustrate SNR estimated considering the SCO influence in a fading channel according to an embodiment.

In FIGS. 8A to 8E, there is a frequency offset of 20 ppm between transmission and reception for frames received across the entire bands of a 320 MHz wideband channel. The graphs of FIGS. 8B to 8E illustrate a distribution of SNR values estimated by the wireless communication device 100 using a cumulative distribution function (CDF).

In the graphs of FIGS. 8B to 8E, both an SNR estimate value calculated separately for each 20 MHz subband within the 320 MHz bandwidth and an overall SNR estimate value calculated for the entire 320 MHz band are shown. The index of the 20 MHz subband has a value within the range of −8≤CH_OFFSET≤−1, +1≤CH_OFFSET≤+8 based on the center frequency of the 320 MHz channel, depending on a CH_OFFSET value.

The wireless communication device 100 according to the disclosure may compensate for the phase rotation of the training symbol in the time domain and frequency domain by using the mathematical relationship between the CFO and SCO. As a result, as shown in FIGS. 8B to 8E, the received SNR may be estimated close to a theoretical value of 40 dB regardless of the frequency band position of the subband in which a signal is received.

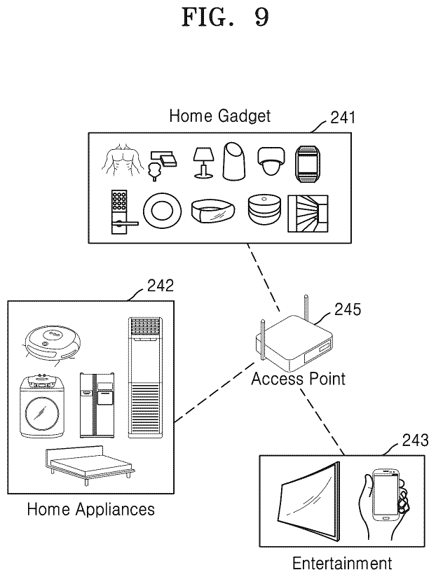

FIG. 9 is a diagram illustrating examples of devices for wireless communication according to an embodiment.

In detail, FIG. 9 illustrates an Internet of Things (IoT) network system including household appliances 241, home appliances 242, entertainment devices 243, and an access point 245.

In some embodiments, the devices for wireless communication of FIG. 9 may consider SCO and CFO-coupled effects appearing to be different depending on the position away from the center frequency, in each subband constituting a wideband channel, as described above and estimate noise power and SNR by considering the effects.

While the disclosure has been particularly shown and described with reference to embodiments thereof, it will be understood that various changes in form and details may be made therein without departing from the spirit and scope of the following claims.

What is claimed is:

1. A method of a wireless communication device, the method comprising:
compensating for a first phase of a first training symbol and a second phase of a second training symbol following the first training symbol, based on a reference carrier frequency offset (CFO) corresponding to one of a plurality of subcarriers of a received frame in a time domain;
calculating residual CFOs respectively for the plurality of subcarriers of the received frame, based on the reference CFO;
compensating for phase differences between the first training symbol and the second training symbol for each of the plurality of subcarriers, based on the residual CFOs in a frequency domain; and
estimating at least one of noise power and signal-to-noise ratio (SNR) of the received frame, based on the first training symbol and the second training symbol after compensating for the phase differences between the first training symbol and the second training symbol, based on the residual CFOs.

2. The method of claim 1, further comprising determining, as the reference CFO, a CFO corresponding to a center frequency of a channel of the received frame.

3. The method of claim 1, further comprising:
detecting a bandwidth of the received frame; and
determining the reference CFO, based on the bandwidth of the received frame.

4. The method of claim 3, wherein the determining the reference CFO comprises determining, as the reference CFO, a CFO corresponding to a center frequency of the bandwidth of the received frame.

5. The method of claim 4, wherein the calculating the residual CFOs comprises calculating residual CFOs respectively for the plurality of subcarriers related to the bandwidth of the received frame.

6. The method of claim 1, further comprising converting the first training symbol and the second training symbol into a signal in the frequency domain, after compensating for the first phase of the first training symbol and the second phase of the second training symbol in the time domain, based on the reference CFO.

7. The method of claim 1, wherein the compensating for the phase differences between the first training symbol and the second training symbol comprises compensating for the second phase of the second training symbol, based on the residual CFOs.

8. The method of claim 1, wherein the estimating at least one of the noise power and the SNR of the received frame comprises estimating at least one of the noise power and the SNR of the received frame, based on a size of a sum of the first training symbol and the second training symbol and based on a size of a difference between the first training symbol and the second training symbol in the frequency domain.

9. A wireless communication device comprising:
a compensator configured to compensate for a first phase of a first training symbol and a second phase of a second training symbol following the first training symbol, based on a reference carrier frequency offset (CFO) corresponding to one of a plurality of subcarriers of a received frame in a time domain;
a CFO calculator configured to determine the reference CFO and determine residual CFOs respectively for the plurality of subcarriers of the received frame, based on the reference CFO; and
a signal-to-noise ratio (SNR) estimator configured to estimate at least one of noise power and an SNR of the received frame, based on the first training symbol and the second training symbol,
wherein the compensator is further configured to compensate for phase differences between the first training symbol and the second training symbol for each of the plurality of subcarriers, based on the residual CFOs in a frequency domain, and
wherein the SNR estimator is further configured to estimate at least one of the noise power and the SNR after the phase differences between the first training symbol and the second training symbol are compensated for by the compensator, based on the residual CFOs.

10. The wireless communication device of claim 9, wherein the CFO calculator is further configured to determine, as the reference CFO, a CFO corresponding to a center frequency of a channel of the received frame.

11. The wireless communication device of claim 9, further comprising:
a bandwidth detector configured to detect a bandwidth of the received frame,
wherein the CFO calculator is configured to determine the reference CFO, based on the bandwidth of the received frame.

12. The wireless communication device of claim 11, wherein the CFO calculator is configured to determine, as the reference CFO, a CFO corresponding to a center frequency of the bandwidth of the received frame.

13. The wireless communication device of claim 12, wherein the CFO calculator is configured to calculate residual CFOs respectively for the plurality of subcarriers related to the bandwidth of the received frame.

14. The wireless communication device of claim 9, further comprising a fast Fourier transform (FFT) module configured to convert the first training symbol and the second training symbol into a signal of the frequency domain, after the first phase of the first training symbol and the second phase of the second training symbol are compensated for, by the compensator, in the time domain, based on the reference CFO.

15. The wireless communication device of claim 9, wherein the compensator is further configured to compensate for the phase differences between the first training symbol and the second training symbol for each of the plurality of subcarriers by compensating for the second phase of the second training symbol, based on the residual CFOs.

16. The wireless communication device of claim 9, wherein the SNR estimator is further configured to estimate at least one of the noise power and the SNR, based on a size of a sum of the first training symbol and the second training symbol, and based on a size of a difference between the first training symbol and the second training symbol in the frequency domain.

17. A method of a wireless communication device, the method comprising:
estimating a frequency offset of a received frame;
determining a reference carrier frequency offset (CFO) corresponding to one of a plurality of subcarriers of the received frame, based on the estimated frequency offset;
compensating for a first phase of a first training symbol and a second phase of a second training symbol following the first training symbol, based on the reference CFO in a time domain;
calculating residual CFOs respectively for the plurality of subcarriers of the received frame, based on the reference CFO;
compensating for phase differences between the first training symbol and the second training symbol for each of the plurality of subcarriers, based on the residual CFOs; and
estimating at least one of noise power and a signal-to-noise ratio (SNR) of the received frame, based on the first training symbol and the second training symbol, after the phase differences of the first training symbol and the second training symbol are compensated for based on the residual CFOs.

18. The method of claim 17, wherein the determining the reference CFO comprises determining, as the reference CFO, a CFO corresponding to a center frequency of a channel of the received frame based on the frequency offset.

19. The method of claim 17, further comprising:
detecting a bandwidth of the received frame,
wherein the determining the reference CFO comprises determining the reference CFO further based on the bandwidth of the received frame.

20. The method of claim 17, wherein the determining the reference CFO comprises determining, as the reference CFO, a CFO corresponding to a center frequency of a bandwidth of the received frame.
